(19) United States
(12) Patent Application Publication
(10) Pub. No.: US 2004/0059999 A1
(43) Pub. Date: Mar. 25, 2004

(54) Logarithmic graph plotting apparatus and program

(75) Inventors: Tomohiro Sudoh, Tokyo (JP); Kouji Matuda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/669,580

(22) Filed: Sep. 23, 2003

(30) Foreign Application Priority Data
Sep. 25, 2002 (JP) 2002-279685

(51) Int. Cl. G06F 17/21

(52) U.S. Cl. 715/502

(57) ABSTRACT

A logarithmic graph plotting apparatus capable of easily setting and displaying x- and/or y-axes as logarithmic ones to thereby display a logarithmic graph. A graph range setting picture (View Window) is displayed by operating a “range” key. The x- and y-coordinate ranges are inputted and set on the graph range setting picture. Graph plot data (x1, y1) (x2, y2), (x3, y3), . . . , (xn, yn) corresponding to any particular graph function expression are calculated based upon the coordinate ranges to thereby plot and display a corresponding a graph in a coordinate system with the x- and y-coordinate axes. When logarithmic graph display check boxes ([ ]x-Log) and/or ([ ]y-Log) on the setting picture (View Window) are checked off, logarithmic scale lines corresponding to the set x- and y-coordinate ranges are set and plotted. In addition, each of the graph plot data (x1, y1) (x2, y2), (x3, y3), . . . , (x, yn) is also converted to a corresponding logarithmic value (log x, log y), which are used to plot and display a corresponding logarithmic graph (FIG. 2).

### BACKGROUND OF THE INVENTION

1. Field of the Invention

The present invention relates to logarithmic graph plotting apparatus and programs.

2. Description of Related Art

When any function expression y=f(x) is inputted in a computer, for example, with a graph displaying function and the computer is instructed to display a graph of the function expression, y-values corresponding to x-values for the respective display dots are sequentially calculated in any x- and y-coordinate ranges set on the display picture and the display dots corresponding to the x- and y-coordinates (x, y) are sequentially lighted up and displayed on the display picture to thereby plot a corresponding graph.

In this case, a user sets the x- and y-coordinate ranges by predicting a range in which the graph is plotted. When the graph actually plotted in these ranges is not desirable, the user can reset, enlarge, reduce and/or move the ranges to thereby display a graph that satisfies the user.

In order to display as a graph data that changes greatly, a coordinate system with a logarithmic coordinate axis is required. In the prior art, however, a graph displayed on the display picture with ordinary, or equi-spaced, scaled x- and y-coordinate axes cannot be changed to a corresponding one displayed on the display picture with logarithmic coordinate axes by one-touch operation in order to see the features of a change in the graph.

In the prior art, in order to display a logarithmic graph, the respective x- and y-coordinate values of the graph are converted to logarithmic values, which are then used to plot the logarithmic graph on the display picture.

One prior art technique has disclosed plotting a graph in a x- and y-coordinate system where the y-axis comprises a fixed logarithmic y-coordinate axis with the x- and y-coordinate ranges determined by the computer.

As described above, the problem with the prior art computer having a graph display function is that the x- and/or y-logarithmic axes cannot easily be set and displayed in desired x- and y-coordinate ranges to thereby display a logarithmic graph.

### SUMMARY OF THE INVENTION

It is therefore an object of the present invention to provide a logarithmic graph plotting apparatus and program capable of simply setting and displaying x- and/or y-logarithmic scales in desired x- and/or y-coordinate ranges to thereby easily display a logarithmic graph.

In a logarithmic graph plotting apparatus according to the present invention, when a range setting unit sets x- and y-coordinate ranges, a graph plotting unit plots a graph in a coordinate system with the x- and y-coordinate ranges set by the range setting unit. A logarithmic scale-marking unit marks x- and/or y-axes with logarithmic scales in the x- and y-coordinate ranges. A logarithmic graph plotting unit plots a logarithmic graph depending upon the logarithmic scales marked on the x- and/or y-coordinate axes.

According to this apparatus, a graph can be plotted in the set x- and y-coordinate ranges as well as a logarithmic graph can be plotted with logarithmic scales being plotted in the same set ranges as mentioned above.

The range setting unit preferably comprises a unit for displaying a range setting picture on which items for setting the x- and y-coordinate ranges, respectively, and items for setting the x- and/or y-axes as corresponding x- and/or y-logarithmic axes, respectively are indicated selectable. The logarithmic scale marking unit preferably marks the x- and/or y-axes with logarithmic scales in the x- and/or y-coordinate ranges set by the corresponding range setting items when the items for setting the x-and/or y-axes as the corresponding x-and/or y-logarithmic axes are selected on the range setting picture.

According to the apparatus, logarithmic scales can be set in correspondence to the set x- and/or y-coordinate ranges and a logarithmic graph can be plotted.

The logarithmic graph plotting apparatus preferably comprises a unit for indicating error when the item for setting the x- and/or y-axes to the corresponding logarithmic axes is selected and the set x- and/or y-coordinate ranges includes a value other than positive value.

According to the apparatus, undesirable range setting in the logarithmic axis setting can easily be corrected.

The logarithmic scales preferably include a plurality of straight lines extending from the corresponding scales on the x- and/or y-logarithmic axes.

According to the apparatus, a plurality of straight lines extending from the corresponding scales on the x- and/or y-logarithmic axes can be displayed clearly to thereby allow a logarithmic graph.

The items for setting the x- and/or y-axes as the corresponding logarithmic axes preferably comprise check boxes to be checked off.

According to the apparatus, display of a logarithmic graph or an ordinary graph with a set logarithmic axis or an ordinary axis can easily be selected depending upon whether or not the check boxes were checked off.

### BRIEF DESCRIPTION OF THE DRAWINGS

FIG. 1 is a block diagram of an electronic circuit of a logarithmic graph plotting apparatus as an embodiment of the present invention;

FIG. 2A shows a range setting picture appearing in the graph plotting process performed by the logarithmic graph plotting apparatus;

FIG. 2B shows another range setting picture appearing in the graph plotting process performed by the logarithmic graph plotting apparatus;

FIG. 2C shows a logarithmic graph display picture appearing in the graph plotting process performed by the logarithmic graph plotting apparatus;

FIG. 2X shows an error indication appearing possibly in the graph plotting process;

FIG. 3A is a flowchart of an internal process as a part of the graph plotting process;

FIG. 3B is a flowchart of an operating process as a part of the graph plotting process;

FIG. 4 is a flowchart of a part of the graph plotting process continued to FIG. 3;

FIG. 5 is a flowchart of a part of the graph plotting process continued to FIG. 4;

FIG. 6A shows x- and y-coordinate ranges set so as to display a graph in a coordinate system based upon ordinary x- and y-coordinate axes in the graph plotting process to be performed by the logarithmic graph plotting apparatus;

FIG. 6B shows a graph display picture with a graph displayed based upon the ordinary coordinate axes in the graph plotting process;

FIG. 6C shows a display picture of a logarithmic graph based upon a logarithmic axis obtained from a graph displayed based upon the ordinary coordinate axes in the graph plotting process;

FIG. 7A shows a polar coordinate graph picture displayed in a coordinate system with ordinary x- and y-coordinate axes when a polar coordinate function expression is inputted in the graph plotting process; and

FIG. 7B shows a polar coordinate graph picture displayed in a coordinate system with polar x- and y-coordinate axes when a polar coordinate function expression is inputted in the graph plotting process.

### DETAILED DESCRIPTION OF THE PREFERRED EMBODIMENTS

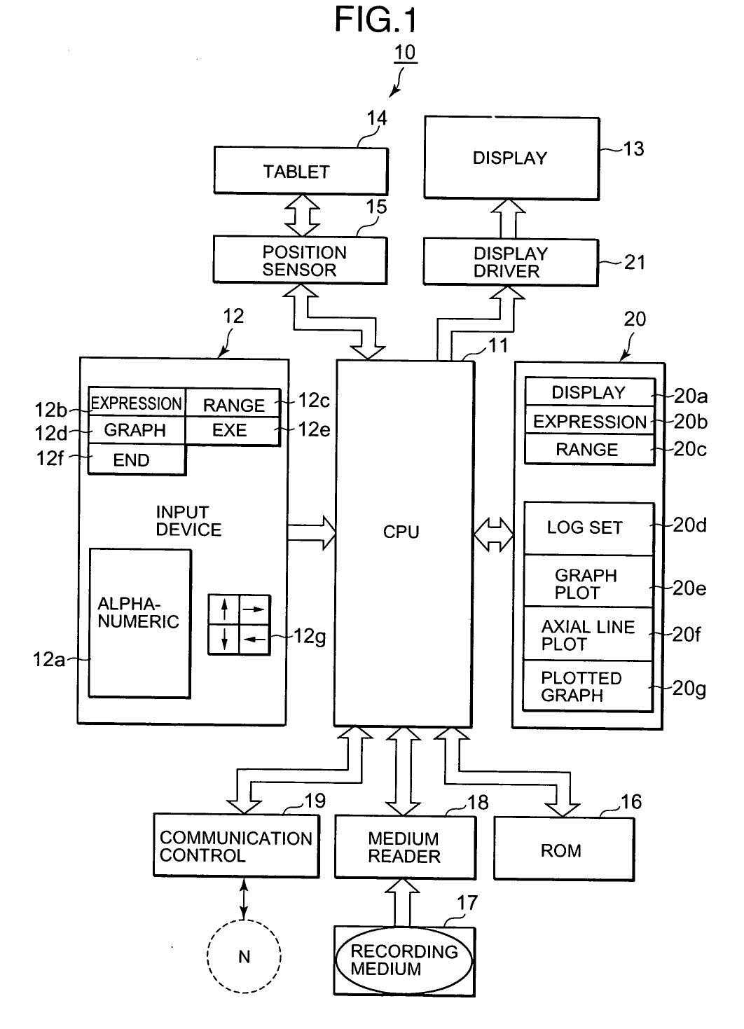

FIG. 1 is a block diagram of an electronic circuit of a logarithmic graph plotting apparatus as an embodiment of the present invention.

Referring to FIG. 1, a logarithmic graph plotting apparatus 10 according to the present invention comprises a computer whose CPU is used as a controller 11. The controller 11 is connected to a key-in device 12, a color liquid crystal display 13 through a display driver 21, a tablet 14, a position sensor 15, a ROM 16, a recording medium reader 18, a communication controller 19, and a RAM 20.

The controller 11 starts up a system program stored beforehand in ROM 16 in accordance with data keyed in by the key-in device 12 and/or touched position data inputted through the position sensor 15 from the tablet 14 superposed on a display screen of the display 13. Alternatively, the controller 11 causes the medium reader 18 to read an apparatus control program stored beforehand in an external recording medium 17 to thereby start up the program. Alternatively, the communication controller 19 causes an apparatus control program received through a communication network N from another computer terminal to be started up. Thus, the apparatus controls the operation of the respective circuits of the apparatus, using the RAM 20 as a work memory.

The key-in device 12 comprises an alphanumerical key unit 12a, an “expression” key 12b, a “range” key 12c, a “graph” key 12d, an “exe” key 12e, an “end” key 12f, and a cursor key unit 12g of “↑”, “↓”, “←” and “→” keys.

The alphanumerical key-in unit 12a comprises keys arranged to input alphabets, numerals, symbols and characters; and various arithmetic symbols and function symbols used to input arithmetic expressions and function expressions.

The “expression” key 12b is used to input any arithmetic expression or function expression y=f(x) newly or to display already input expression data.

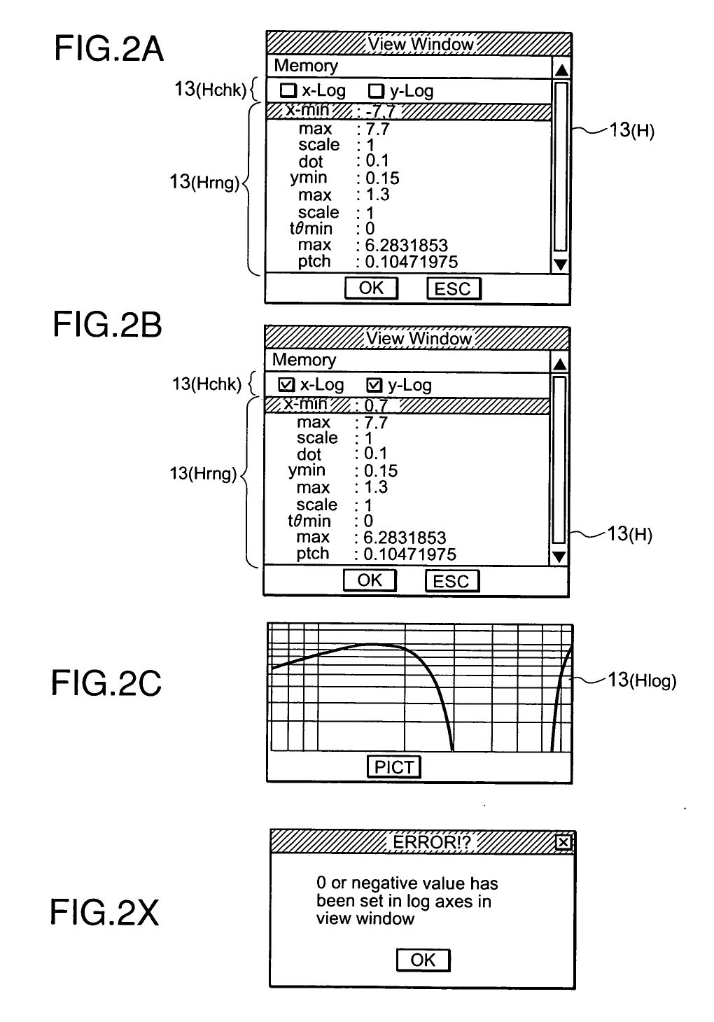

The “range” key 12c is operated to display a range setting picture (View Window) (FIG. 2A) to input and set the respective display ranges of x- and y-coordinates on a display picture that displays a graph.

The “graph” key 12d is operated to instruct the apparatus to plot and display a graph corresponding to the inputted function expression y=f(x) or inputted measured data.

The “exe” key 12e is operated to instruct the apparatus to execute a specified or selected operation, and to fix the data.

The “end” key 12f is operated to terminate the operation being performed.

The cursor key unit 12g is operated to select and scroll the respective displayed data, and/or to move the cursors and pointer.

The tablet 14 is superposed on a display screen of the color liquid crystal display 13 and produces a voltage signal depending upon a position where the tablet is touched. The coordinates of the position on the display screen where the tablet 14 is touched is sensed by the position sensor 15 based upon the voltage signal outputted by the tablet 14. The controller 11 determines what operation should be performed, in accordance with the coordinates of the touched position.

ROM 16 has stored a system program in charge of a whole process to be performed by the electronic circuit of the apparatus 10, as well as application programs for calculation, graphic representation, program processing, and data inputting, etc.

RAM 20 includes a display data memory 20a, an expression data memory 20b, a range data memory 20c, a logarithm setting data memory 20d, a graph plotting data memory 20e, an axis plotting data memory 20f, a plotted graph data memory 20g, and a work area.

The display data memory 20a stores data to be displayed on the liquid crystal display 13 in the various processing operations, the data being developed and stored in the form of a bit map pattern in the memory 20a.

The expression data memory 20b stores any keyed-in function expressions y=f(x) and any calculating expressions with corresponding serial numbers.

The range data memory 20c stores the x- and y-coordinate ranges for the graph display inputted in the range setting picture (View Window) (FIG. 2A) by operating the “range” key 12c.

The logarithm setting data memory 20d stores the set x- and y-coordinate ranges as the respective logarithmic coordinate ranges when logarithmic-graph-displaying check boxes [ ]x-Log and/or [ ]y-Log were checked off on the range setting picture (View Window) (FIG. 2B) displayed by operating the “range” key 12c.

The graph plot data memory 20e stores the respective graph plot data (x1, y1), (x2, y2), (x3, y3), . . . , (xn, yn) calculated in accordance with the x- and y-axial coordinate ranges set and stored in the range data memory 20c in correspondence to the graph function expression stored in the expression data memory 20b.

The axis line plotting data memory 20f stores various arithmetic data required in plotting and displaying graphic coordinate axes such as x- and y-ordinary, or equi-spaced, scaled coordinate axes corresponding to the ordinary scaled x- and y-coordinate ranges and the x- and y-logarithmic coordinate axes corresponding to the logarithmic x- and y-coordinate ranges.

The plotted graph data memory 20g stores in the same memory area as the display data memory 20a data plotting the x- and y- equi-spaced scaled coordinate axis lines and logarithmic scale lines calculated in accordance with the x- and y-coordinate ranges set and stored in the range data memory 20c, and graph data plotted in accordance with the graph plotting data (x1, y1), (x2, y2), (x3, y3), . . . , (xn, yn) stored in the graph plotting data memory 20e.

FIGS. 2A, 2B, 2C and 2X show the range setting picture (View Window), the logarithmic graph display picture (Hlog) appearing when a graph is displayed in the apparatus 10, and an error indicating picture.

As shown in FIG. 2A, the apparatus 10 stores any x- and y-coordinate ranges for the graph display in the range data memory 20c by inputting the x- and y-coordinate ranges in numerical values in the range setting area Hrng on the range setting picture (View Window).

As shown in FIG. 2B, at this time, when the x- and y-direction logarithmic graph display check boxes ([ ]x-Log and/or [ ]y-Log) in the check box area Hchk for the logarithmic graph display are checked off, data (flag) for setting the logarithmic coordinate axes is set in the logarithmic setting data memory 20d. Thus, as shown in FIG. 2C, the graph data is fed, logarithmic coordinate axes (scales) for the x- and y-coordinate ranges are plotted, and a logarithmic graph is plotted and displayed on the logarithmic graph picture Hlog with scale lines extending from the logarithmic coordinate axes being displayed.

As shown in FIG. 2A, if zero or a negative number has been set in the x- and y-coordinate ranges when the logarithmic graph display check boxes [ ]x-Log and/or [ ]y-Log (Hchk) were checked off “error” is indicated to thereby urge the user to set a positive value (FIG. 2X).

A graph plotting function of the apparatus will be described next.

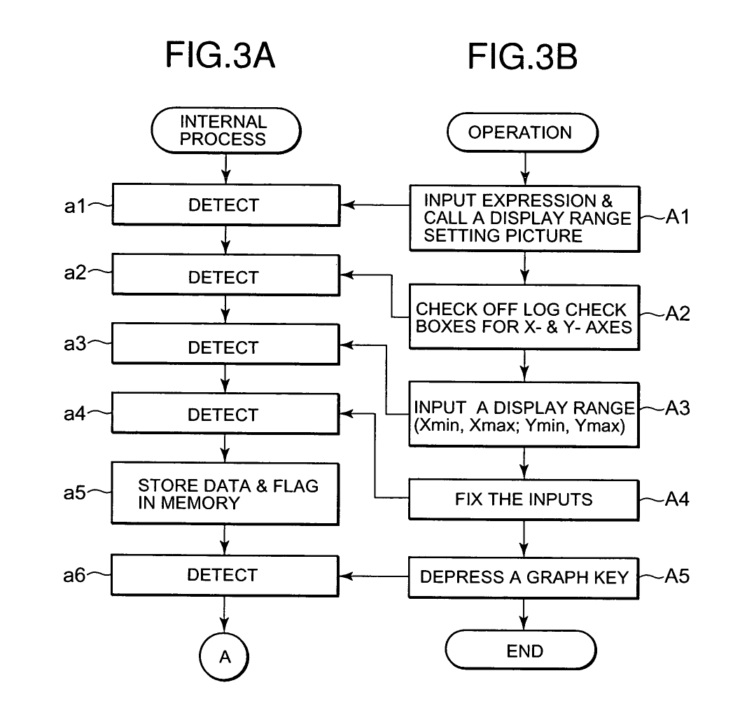

FIG. 3A is a flowchart of an internal process as a part of the graph plotting process.

FIG. 3B is a flowchart of an operating process as a part of the graph plotting process.

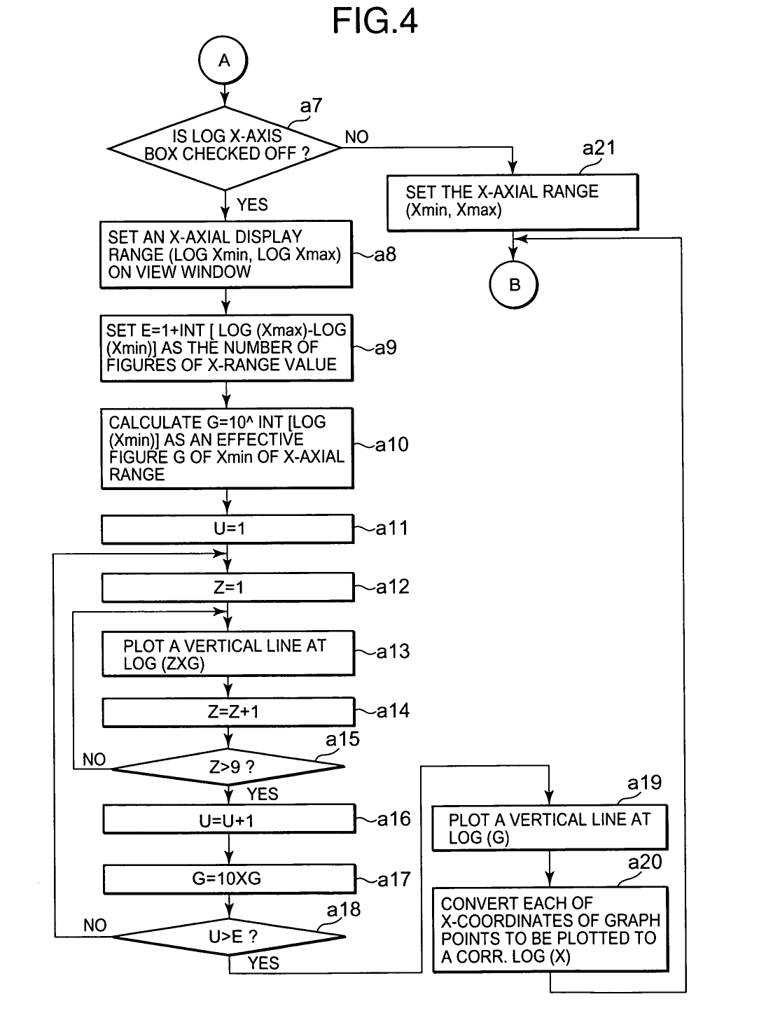

FIG. 4 is a flowchart of a part of the graph plotting process continued to FIG. 3.

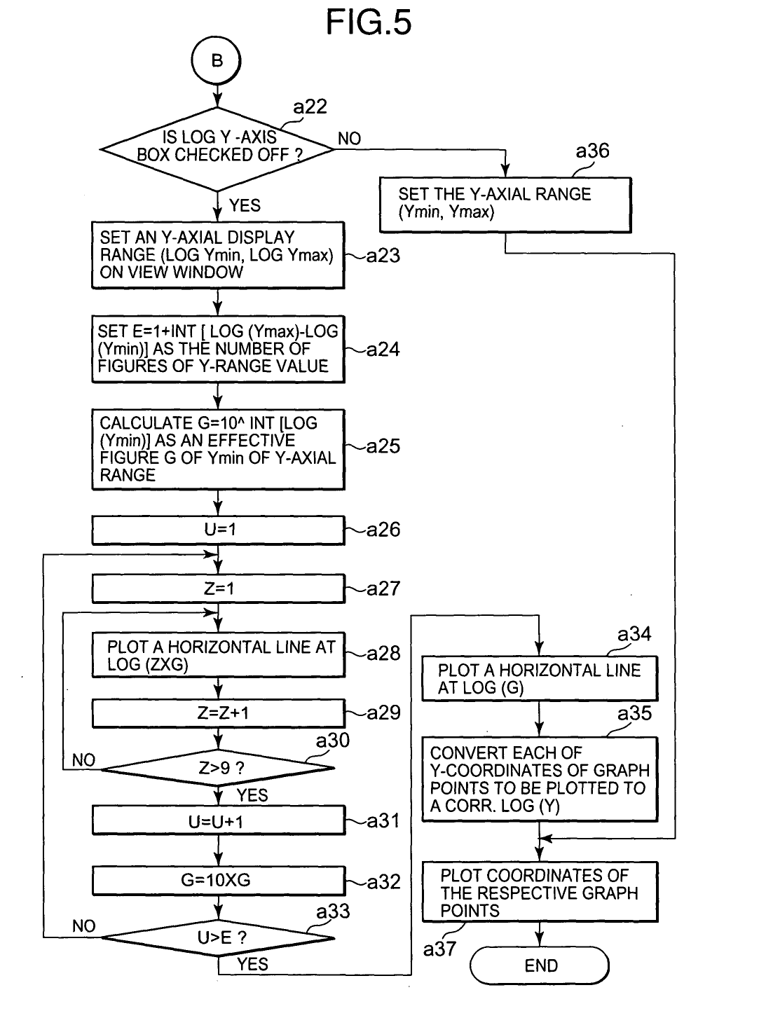

FIG. 5 is a flowchart of a part of the graph plotting process continued to FIG. 4.

Referring to FIGS. 3-5, when any function expression y=f (x) to be expressed as a graph is inputted in the expression input display picture displayed on the liquid crystal display 13 by operating the “expression” key 12b of the key-in device 12, data on the inputted function expression is stored in the expression data memory 20b of RAM 20. When the “range” key 12c is then operated, the range setting picture (View Window) to set a graph display range is displayed on the display 13 as shown in FIG. 2A (step A1→a1).

When a logarithmic graph is to be displayed by displaying logarithmic scale lines on the range setting picture (View Window), the x- and y-logarithmic graph display check boxes [ ]x-Log and/or [ ]y-Log of a logarithmic graph display check box area Hchk on the setting picture is checked off. Thus, the logarithmic scale lines corresponding to the range setting is enabled to be plotted and a logarithmic graph is enabled to be displayed effectively (step A2→a2).

Then, a graph display range (Xmin, Xmax; Ymin, Ymax) is inputted and set in the range setting area Hrng of the graph range setting picture (step A3→a3). When the “exe” key 12e is operated and the input is then fixed (step A4→a4), the presence/absence of the set logarithmic graph is stored in the logarithmic setting data memory 20d, and data setting the x- and y-coordinate ranges corresponding to the inputted graph display range is stored in the range data memory 20c (step a5).

If zero or a negative value is set in the x- or y-coordinate range when the logarithmic graph display check boxes [ ]x-Log and/or [ ]y-Log were checked off, “error” is displayed and the user is urged to set a positive value instead.

When the “graph” key 12d is operated to plot and display a graph of the function expression y=f(x) stored in the expression data memory 20b (step A5→a6), the x- and y-coordinate axes are set at steps a7-a21 and a22-a35, respectively. Thus, the graph is plotted and displayed in a coordinate system with the ordinary (equi-spaced scaled) or logarithmic x- and y-coordinate axes. More specifically, when the “graph” key 12d is operated to instruct the apparatus to plot and display the graph, it is checked whether or not the logarithmic graph display check box [ ]x-Log was checked off in the logarithmic graph display check box area Hchk based upon the set x-axial logarithmic data stored in the logarithmic setting data memory 20d (step a7).

When it is determined that the check box [ ]x-Log or display of the logarithmic graph is set for the x-axis, an x-logarithmic axis coordinate range (log (Xmin), log (Xmax)) is calculated based upon the x-coordinate range (Xmin, Xmax) stored in the range data memory 20c and set as such (step a7→a8).

Thereupon, the number of figures of a numerical value indicative of the x-axial logarithmic coordinate range, E, shown by Expression (1) below is set and stored in the axial line plotting data memory 20g (step a9):

E=1+Int [log(Xmax)−log(Xmin)] Expression (1)

where Int indicates an integer part of a logarithm.

When the x-axial coordinate range is, for example, (Xmin=1) and (Xmax=10), the number of figures of its numeral value, E, is 2.

Then, the effective figure value G of the minimum value Ymin of the y-axial display range is calculated in accordance with the following expression (2) and stored in the axial line plotting data memory 20g (step a10):

G=10\hat{ }Int(log(Xmin)) Expression (2)

Thereupon, the count of the figure counter U indicative of a specified one of the figures of the numerical value indicative of the x-axial range in which specified figure a plurality of x-axial logarithmic scale lines are plotted is set to 1 (step a11) and an axial-scale line counter Z for counting the number of scale lines to be plotted along the x-axis in the figure is set to 1 (step a12).

Thereupon, a vertical scale line at log (Z×G), i.e. a first logarithmic scale line of the minimum figure of the x-axial display range where Z=1 in this case, is plotted on the graph plotting data memory 20g (step a13), and the axial-scale line counter Z is incremented (Z=Z+1) (step a14).

It is then determined whether or not the axial-scale line counter Z has exceeded 9 for the figure, for example, 9 x-axial logarithmic scale lines “0.1, 0.2, 0.3, . . . , 0.9” for the position of “0.1” or 9 x-axial logarithmic scale lines “1, 2, 3, . . . , 9” for the position of “1” have been plotted (step a15). If the count of the axial-line counter Z for the figure concerned is less than 9, an x-axial logarithmic scale line indicated by the minimum effective figure value G of the x-direction display range multiplied by the count of the axial-scale line counter Z is further plotted by incrementing the count of the axial-scale line counter Z (step a13-a15).

Then, at step a14 the axial-scale line counter Z is incremented to “10”. Then, when it is determined at step a15 that 9 x-axial logarithmic scale lines for the figure have been plotted and therefore Z>9, the figure counter U is incremented (U=U+1) (step a16).

Thereupon, the minimum effective figure value G of the x-axis direction display range is multiplied by 10 (G=10×G), which is then set as the minimum numerical value of the next figure on the x-logarithmic axis (step a17). Then, it is determined whether or not the count of the figure counter U has exceeded the whole number of figures, E, for the set display range (step a18).

If it is then determined that U≦E, that is, if the count of the figure counter U has not exceeded the whole number of figures, E, and hence it is determined that x-axial logarithmic scale lines for all the figures of the numerical value indicative of the set display range have not all been plotted, the processing returns to step a12, in which the axial-scale line counter Z for the figure concerned is reset to 1. Then, the respective x-axial logarithmic scale lines, for example, “10, 20, 30, . . . , 90” for the position of “10” are plotted based upon the minimum numerical value G of the next figure on the x-logarithmic axis updated and set at step a17 (steps a13-a15).

In this way, groups of 9 x-axial logarithmic scale lines for the respective figures of the numerical value indicative of the set display range are plotted sequentially. Then, if it is determined at step a18 that U>E, that is, if the count of the figure counter U has exceeded the whole number of figures, E, of the numerical value indicative of the set display range and hence the x-axial logarithmic scale lines for the whole number of figures have been all plotted, an x-axial logarithmic scale line corresponding to the minimum value G of the next figure on the x-logarithmic scale axis updated at step al7 is plotted for doubling assuring purposes (step a19). For example, when the numerical value indicative of the y-axial set display range includes 2 figures and when the x-axial logarithmic scale lines “0.1, 0.2, 0.3, . . . , 0.9”, and “1, 2, 3, . . . , 9” for the positions of “0.1” and “1”, respectively, have been plotted for the set display range, the minimum x-axial logarithmic scale line “10” for the next figure “10” is plotted as the last x-axial logarithmic scale line, for doubly assuring purposes.

Thereupon, the respective x-coordinates of the points indicated by the graph plot data (x1, y1), (x2, y2), (x3, y3), . . . , (xn, yn) calculated in accordance with the graph function expressions stored in the expression data memory 20b and the x- and y-coordinate ranges (Xmin, Xmax, Ymin, Ymax) stored in the range data memory 20c are converted to corresponding logarithmic values log (x) (step a20).

When the determination at step a7 is “No”, i.e. when it is determined that no display of logarithmic scales is set for the x-axis, the x-coordinate range (Xmin, Xmax) stored in the range data memory 20c is directly set and plotted as a coordinate range in the x-axis direction (step a21).

Thereupon, it is determined based upon the y-axial logarithmic set data stored in the logarithmic set data memory 20d whether or not the logarithmic graph display check box ([ ]y-Log) has been checked off in the logarithmic graph display check box area Hchk (step a22).

When it is determined that a logarithmic graph display is set for the y-axis, or the logarithmic graph display check box ([ ]y-Log) has been checked off, a y-coordinate range (log (Ymin), log (Ymax)) for the logarithmic axis is calculated based upon the y-coordinate range (Ymin, Ymax) stored in the range data memory 20c and set as the y-axial logarithmic coordinate range (step a22→a23).

Thereupon, the number of figures of the numerical value indicative of the y-axial logarithmic coordinate range, E, shown by Expression (3) below is stored in the axial line plotting data memory 20g (step a24):

E=1+Int [log(Ymax)−log(Ymin)] Expression (3)

where Int indicates an integer part of a logarithm.

When the y-axial coordinate range is, for example, (Ymin=1) and (Ymax=500), the number of figures E is 3.

Then, the effective figure value G of the minimum value Ymin of the y-axial display range is calculated in accordance with the following expression (4) and stored in the axial line plotting data memory 20g (step a25):

G=10\hat{ }Int(log(Ymin)) Expression (4)

Thereupon, the figure counter U indicative of a figure in which a plurality of y-axial logarithmic scale lines are plotted is set to 1 (step a26) and an axial-scale line counter Z for the figure “1” is set to 1 (step a27).

Thereupon, a horizontal line at log (Z×G), i.e. a first logarithmic scale line of the minimum figure of the y-axial display range where Z=1 in this case, is plotted on the graph plotting data memory 20g (step a28), and the axial-scale line counter Z is then incremented (Z=Z+1) (step a29).

It is then determined whether or not the axial line counter Z has exceeded 9 for the figure, or 9 y-axial logarithmic scale lines for the figure, for example, 9 y-axial logarithmic scale lines “10, 20, 30, . . . 90” for the position of “10” or 9 y-axial logarithmic scale lines “100, 200, 300, . . . , 900” for the position of “100” have been plotted (step a30). If the count of the axial-scale line counter Z for the figure concerned is less than 9, a y-axial logarithmic scale line indicated by the minimum effective figure value G of the y-axial direction display range multiplied by the count of the axial-scale line counter Z is further plotted by incrementing the count of the counter Z (step a28-a30).

Then, at step a29, the axial-scale line counter Z is incremented to “10”. Then, when it is determined at step a30 that 9 y-axial logarithmic scale lines for the figure have been plotted and therefore Z>9, the figure counter U is incremented (U=U+1) (step a31).

Thereupon, the minimum effective figure value G of the y-axis direction display range is multiplied by 10 (G=10×G), which is then set as the minimum value of the next figure on the y-logarithmic axis (step a32). Then, it is determined whether or not the count of the figure counter U has exceeded the whole number of figures, E, for the set display range (step a33).

If it is determined that U≦E, that is, if the count of the figure counter U has not exceeded the number of figures, E, and that y-axial logarithmic scale lines for all the figures of the numerical value indicative of the set display range have not all been plotted, the processing returns to step a27, in which the axial-scale line counter Z for the figure concerned is reset to 1. Then, the respective y-axial logarithmic scale lines, for example, “10, 20, 30, 90” for the position of “10” are plotted based upon the minimum numerical value G of the next figure on the y-logarithmic axis updated at step a32 (steps a28-a30).

In this way, groups of 9 y-axial logarithmic scale lines for the respective figures of the numerical value indicative of the set y-axial display range are plotted sequentially. Then, if it is determined at step a33 that U>E, that is, if the count of the figure counter U has exceeded the whole number of figure, E, and the y-axial logarithmic scale lines for the whole number of figures of the numerical value indicative of the set display range have been all plotted, a y-axial logarithmic scale line corresponding to the minimum value G of a figure next to the y-axial logarithmic scale line updated step a32 is plotted (step a34). For example, when the numerical value indicative of the y-axial set display range includes 3 figures and when the y-axial logarithmic scale lines “1, 2, 3, . . . , 9”, “10, 20, 30, . . . , 90”, and “100, 200, 300, . . . , 900” for the positions of “1”, “10” and “100” have been plotted for the set display range, the minimum y-axial logarithmic scale line “1000” for the next position of “1000” is plotted as the last y-axial logarithmic scale line, for doubly assuring purposes.

Whereupon, the respective y-coordinates of the points indicated by the graph plot data (x1, y1), (x2, y2), (x3, y3), . . . , (xn, yn) calculated in accordance with the graph function expressions stored in the data memory 20b and the x- and y-coordinate ranges (Xmin, Xmax; Ymin, Ymax) stored in the range data memory 20c are converted to corresponding logarithmic values log (y) (step a35).

When the determination at step a22 is “No”, or it is determined that no display of logarithmic scales is set for the y-axis, the y-coordinate range (Ymin, Ymax) stored in the range data memory 20c is directly set and plotted as a coordinate range in the y-axis direction (step a36).

As described above, when the logarithmic graph display check box ([ ]x-Log) was checked off in the graph range setting picture (View Window), logarithmic scale lines in the x-axis direction depending upon the set x-axis coordinate range are plotted and the respective x-coordinates of the graph plot data (x1, y1), (x2, y2), (x3, y3), . . . , (xn, yn) are converted to corresponding logarithmic values log (x) at steps a7-a20. When the ([ ]y-Log) was checked off, the y-axial logarithmic scale lines are plotted depending upon the set y-coordinate range. In addition, the y-coordinates of the points indicated by the graph plot data (x1, y1), (x2, y2), (x3, y3), . . . , (xn, yn) are converted to corresponding logarithmic values log y at steps a22-a35.

When no check boxes ([ ]x-Log) and ([ ]y-Log) are checked off, the set x- and y-coordinate ranges (Xmin, Xmax) and (Ymin, Ymax) are directly plotted as the x- and y-axial coordinate ranges, respectively.

When the logarithmic scale lines are plotted for both the x- and y-axes, a logarithmic graph is plotted and displayed as a logarithmic graph display picture Hlog on the display 13 in accordance with the x- and y-logarithmic values (log x, log y) of the graph plot data converted at steps s20 and a35, as shown in FIG. 2C (step a37).

When the logarithmic scale lines for only the x-axis are plotted, a graph is plotted and displayed with x-logarithmic values log x of the graph plot data indicating the respective points converted at step a20 and unconverted ordinary, or equi-spaced, scaled y-plot values (step a37).

The logarithmic scale lines are plotted only for the y-axis, a graph is plotted and displayed with x-plot values of the graph plot data not converted at step s35 and the y-logarithmic values log y (step a37).

When the ordinary x- and y-coordinate axis lines are plotted for the x- and y-axes, respectively, a graph is plotted and displayed in accordance with the graph plot data (x1, y1), (x2, y2), (x3, y3), (xn, yn) indicating the respective x- and y-coordinates (step a37).

Thus, one of a graph display process including the plotting of the ordinary (or equi-spaced scaled) x- and y-coordinate axes and a logarithmic graph display process including the plotting of the x- and y-logarithmic scale lines can be easily selected depending upon whether or not the logarithmic graph display check boxes ([ ]x-Log) and/or ([ ]y-Log) are checked off on the graph setting picture (View Window) of FIG. 2A or 2B.

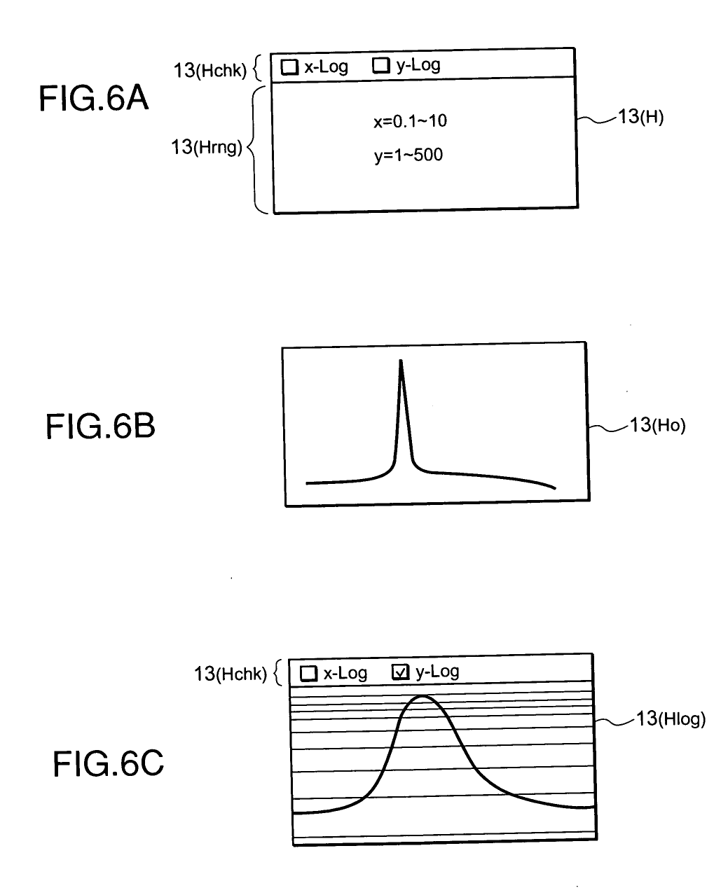

FIG. 6 shows a picture obtained when the x- and y-ranges were set a picture of a graph displayed based upon the ordinary coordinate axes and then a picture of a corresponding graph displayed based upon the logarithmic axes, in the logarithmic graph plotting apparatus 10.

More particularly, as shown in FIG. 6A, after a function expression “y=sin x+eⁿ . . .+. . .” to be expressed as a graph is inputted, an x-coordinate range (Xmin=0.1, Xmax=10) and a y-coordinate range (Ymin=1, Ymax=500) are inputted. Then, the corresponding x- and y-coordinate axes are set and plotted to thereby display an ordinary graph display picture H0, as shown in FIG. 6B.

As shown, at this time, when, for example, a graph is plotted in which a y-value rapidly changes to a very high value in a narrow x-range, the graph range setting picture (View Window) can again be displayed and then the y-direction logarithmic graph display check box ([ ]y-Log) in the logarithmic graph display check box area Hchk can be checked off, in order to display the rapid change in the graph in a logarithmic graph representation, as shown in FIG. 6C.

Thereupon, in the graph plotting process of FIGS. 3-5, the ordinary x-coordinate axis is set and plotted in the x-coordinate range (Xmin=0.1, Xmax=10) in the x-axis direction at step a7→a21. In addition, at steps a22-a35 y-logarithmic scale lines “1, 2, 3, . . . , 9; 10, 20, 30, . . . , 90; 100, 200, 300, . . . , 900, 1000” are plotted based upon the y-coordinate range (Ymin=1, Ymax=500) in the y-axis direction to thereby plot and display a corresponding logarithmic graph.

Thus, in this case the logarithmic graph display picture Hlog, capable of clearly indicating a peculiar y-direction change characteristic is easily selected to thereby plot and display the corresponding graph.

Therefore, according to the graph plotting function of this logarithmic graph plotting apparatus, x- and y-coordinate ranges are inputted to and set on the graph range setting picture (View Window) displayed by operating the “range” key 12c. Graph plot data (x1, y1) (x2, y2), (x3, y3), . . . , (xn, yn) corresponding to any particular graph function expression are calculated and plotted as a graph in a coordinate system with the x- and y-coordinate axes based on the coordinate ranges. When the logarithmic graph display check boxes ([ ]x-Log) and ([ ]y-Log) in the logarithmic graph display check box area Hchk are checked off, the logarithmic coordinate axes corresponding to the set x- and y-coordinate ranges are set and plotted. In addition, the graph plot data (x1, y1) (x2, y2), (x3, y3), . . . , (xn, yn) are also converted to the corresponding logarithmic values (log x, log y), which are then used to plot and display a corresponding logarithmic graph. Thus, the logarithmic graph can be displayed on the logarithmic scale lines set on the picture in a very simple manner. In addition, the display picture can be easily changed from a graph display picture H0 based upon the ordinary coordinate axis to one Hlog based upon the logarithmic coordinate axis.

According to the graph plotting function of the present logarithmic graph plotting apparatus, if a negative value has been set in the x- and y-coordinate ranges when the logarithmic graph display check boxes ([ ]x-Log and/or[ ]y-Log) are checked off on the graph range setting picture (View Window), “error” is displayed to thereby urge the user to change the negative value to a positive one. Thus, undesirable range setting can be eliminated beforehand when the logarithmic graph is displayed.

The function of selecting one of the graph display process to be performed after the plotting of the ordinary coordinate axis and the logarithmic graph display process to be performed after the plotting of the logarithmic scale lines, as described in the present embodiment, applies likewise to a graph representation and/or a parameter graph representation in the polar coordinate system.

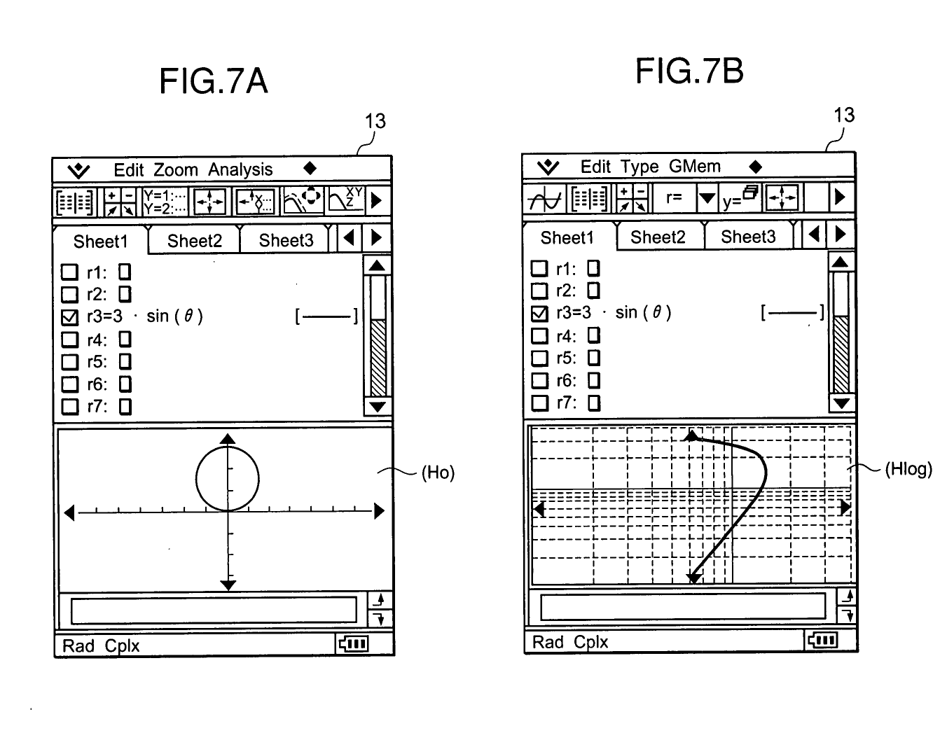

FIGS. 7A and 7B show a polar-coordinate graph display picture H0 with the ordinary x- and y-coordinate axes plotted when a polar-coordinate function expression was inputted, and a polar-coordinate logarithmic graph display picture Hlog with the plotted logarithmic scale lines, respectively, in the logarithmic graph plotting apparatus 10. More particularly, as shown in FIG. 7A, in a state where a polar-coordinate function expression r3=3·sin θ is inputted and a polar-coordinate graph display picture H0 is displayed in the ordinary x- and y-coordinates, a polar-coordinate logarithmic graph display picture Hlog based upon the plotting of the logarithmic scale lines is easily displayed only by checking off the logarithmic graph display check boxes ([ ]x-Log) and/or ([ ]y-Log) on the graph range setting picture (View Window), as shown in FIG. 7.

As described above, the logarithmic graph plotting method described above in this embodiment may be applied to the graphic and parametric representation of the polar-coordinate function expression.

As shown in FIG. 7B, the logarithmic scale lines may be plotted in broken lines or indicated in a color thinner than the graph color.

The logarithmic scales may be displayed extending in a very short solid or dotted line from its x- or y-axis.

The methods described with reference to the present embodiment, that is, the graph plotting processes shown by the flowcharts of FIGS. 3-5 may be stored and distributed as programs executable by the computers on external recording media 17 such as memory cards (ROM/RAM cards), magnetic disks (floppy disks, hard disks), optical disks (CD-ROMs, DVDs), and semiconductor memories. The computer is capable of reading the programs stored in the external recording mediums 17, using the reader 18, and controlling its operation by the read programs to thereby fulfilling the logarithmic graph displaying function to be performed after the plotting of the logarithmic scale lines described in the respective embodiments to thereby perform the processes mentioned above.

The logarithmic graph plotting apparatus is also capable of transmitting program data to implement the respective methods in the form of program codes through the network N, and acquiring the program data through the communication controller 19 of the apparatus through the network to thereby fulfilling the logarithmic graph display function to be performed after the plotting of the logarithmic scale lines.

Various embodiments and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2002-279685 filed on Sep. 25, 2002 and including specification, claims, drawings and summary. The disclosure of the above Japanese patent application is incorporated herein by reference in its entirety.

What is claimed is:

1. A logarithmic graph plotting apparatus comprising:
a range setting unit for setting x- and y-coordinate ranges;
a graph plotting unit for plotting a graph in a coordinate system with the x- and y-coordinate ranges set by the range setting unit;
a logarithmic scale marking unit for marking x- and/or y-axes with logarithmic scales in the x- and y-coordinate ranges set by the range setting unit; and
a logarithmic graph plotting unit for plotting a logarithmic graph depending upon the logarithmic scales marked on the x- and/or y-coordinate axes by the logarithmic scale marking means.

2. The logarithmic graph plotting apparatus according to claim 1, wherein the range setting unit comprises a unit for displaying a range setting picture on which items for setting the x- and y-coordinate ranges, respectively, and items for setting the x- and/or y-axes as corresponding x- and/or y-logarithmic axes, respectively are indicated selectable; and
the logarithmic scale marking unit marks the x- and/or y-axes with logarithmic scales in the x- and/or y-coordinate ranges set by the corresponding range setting items when the items for setting the x- and/or y-axes as the corresponding x- and/or y-logarithmic axes are selected on the range setting picture.

3. The logarithmic graph plotting apparatus according to claim 1, comprising a unit for indicating error when the items for setting the x- and/or y-axes as the corresponding x- and/or y-logarithmic axes are selected and the set x- and/or y-coordinate ranges includes a value other than a positive value.

4. The logarithmic graph plotting apparatus according to claim 1, wherein the logarithmic scales include a plurality of straight lines extending from the corresponding scales on the x- and/or y-logarithmic axes.

5. The logarithmic graph plotting apparatus according to claim 1, wherein the items for setting the x- and/or y-axes as the corresponding logarithmic axes comprise check boxes to be checked off.

6. A computer-readable recording medium having recorded a logarithmic graph plotting program for controlling a computer of a graph plotting apparatus, the program causing the computer to function as:
a range setting unit for setting x- and y-coordinate ranges;
a graph plotting unit for plotting a graph in a coordinate system with the x- and y-coordinate ranges set by the range setting unit;
a logarithmic scale marking unit for marking x- and/or y-axes with logarithmic scales in the x- and y-coordinate ranges set by the range setting unit; and
a logarithmic graph plotting unit for plotting a logarithmic graph depending upon the logarithmic scales marked on the x- and/or y-coordinate axes by the logarithmic scale marking means.
